(19) United States
(12) Patent Application Publication
(10) Pub. No.: US 2024/0172764 A1
(43) Pub. Date: May 30, 2024

(54) METHOD FOR MAKING DOUGH PRODUCTS

(71) Applicant: FRITSCH BAKERY TECHNOLOGIES GMBH & CO. KG, Markt Einersheim (DE)

(72) Inventors: Michael GIER, Kitzingen (DE); Oliver LEHMANN, Tauberbischofsheim (DE)

(73) Assignee: FRITSCH BAKERY TECHNOLOGIES GMBH & CO. KG, Markt Einersheim (DE)

(21) Appl. No.: 18/518,867

(22) Filed: Nov. 24, 2023

(30) Foreign Application Priority Data
Nov. 25, 2022 (DE) 102022131225.9

(51) Int. Cl. A21C 9/08

(52) U.S. Cl. CPC A21C 9/088

(57) ABSTRACT

A method for making dough products comprises providing a first dough piece on a first conveyor, supplying a second dough piece on a second conveyor, and depositing the second dough piece on the first dough piece, while the first dough piece is disposed on the first conveyor. The second dough piece is folded during the depositing.

### CROSS-REFERENCE TO RELATED APPLICATIONS

This application claims foreign priority benefits under 35 U.S.C. § 119(a)-(d) to German patent application number DE 10 2022 131 225.9 filed Nov. 25, 2022, which is incorporated by reference in its entirety.

### TECHNICAL FIELD

The disclosure relates to a method for making dough products.

### BACKGROUND

Dough products are being offered in a variety of shapes. Some shapes traditionally generated by hand pose a challenge for industrial production. It is conceivable to design complex de-vices each for making one of this variety of traditionally handmade shapes. However, one specialized device for each individual shape is inefficient and only practicable for high lot sizes.

Devices for making dough products are known, which comprise two or more conveyor belts, on which dough portions are conveyed. Conventionally, they are used to adjust spacing between the dough portions being conveyed, e.g., by transferring the dough portions between conveyor belts, which are driven at different speeds.

### SUMMARY

It is an objective of the disclosure to provide a method, which increases the diversity of shapes of dough products generatable by conventional devices.

A method for making dough products is disclosed. The method comprises providing a first dough piece on a first conveyor, supplying a second dough piece on a second conveyor and depositing the second dough piece on the first dough piece, while the first dough piece is disposed on the first conveyor, wherein the second dough piece is folded during the depositing.

Folding and depositing the second dough piece on the first dough piece, may enable generating a shape of dough product, which resembles a product traditionally made by hand without having to design or provision a specialized device. This may enhance the range of usage of conventional devices for making dough products and at the same time reduce the share of manual labor in the making of traditional dough products.

The method may further comprise transferring the first dough product from the second conveyor to the first conveyor prior to providing the first dough piece on the first conveyor. In this way, the first and the second dough product may be supplied by the same conveyor, in particular the second conveyor. This may simplify the structure of the device because the first and the second dough piece do not have to be initially transported on a plurality of conveyors. This may be advantageous in particular in combination with embodiments, in which the first and the second dough piece are severed from the same dough strand because the dough pieces do not have to be distributed to two conveyors.

It is conceivable that the method further comprises wrapping the first and the second dough piece, after the second dough piece has been deposited on the first dough piece. The wrapping may be effected e.g., by a winding mat or by a conveyor belt running in opposite direction and engaging the dough pieces from above. By wrapping the first dough piece and the second dough piece folded and deposited thereon, a desired shape of dough product may be generated.

Advantageously, the first conveyor may comprise a first conveyor belt. Additionally or alternatively, the second conveyor may comprise a second conveyor belt.

It may be advantageous if the second dough piece is folded in such a way that a fold points into a production direction. This may facilitate or support the wrapping, for example in such a way that the desired shape of dough product is generated. The production direction may correspond to a direction, in which the dough pieces or prior the dough strand and after that the dough products, respectively, pass through the different production steps. The production direction does not necessarily have to correspond to a conveying direction at every location. For example, the dough strand, the dough pieces or the dough products may be conveyed opposite the production direction at some locations.

The method may comprise severing the first and the second dough piece from a dough strand, in particular from the same dough strand, prior to providing the first dough piece on the first conveyor. Alternatively or additionally, the method may further comprise severing the first and the second dough piece from a dough strand prior to transferring the first dough product from the second conveyor to the first conveyor. Severing the first and the second dough piece from one dough strand may facilitate execution of the method by conventional dough processing devices because devices for simple severing of dough pieces from a dough strand are widely available.

It may be particularly beneficial if the first and the second dough piece are consecutively severed and preferably conveyed. Consecutively severed and/or conveyed first and second dough pieces may enable that the dough pieces arrive at the first and/or second conveyor in a particularly suitable sequence. This may enable the method to be carried out more efficiently. For example, sorting and/or spacing processes may be reduced by consecutively severing and conveying the dough pieces.

Advantageously, the second conveyor may have a higher conveying speed in the production direction than the first conveyor during the depositing. On this occasion, the conveying speed of the first conveyor may be zero, i.e., the first conveyor may be stopped during the depositing. Alternatively, the conveying speed in the production direction of the first conveyor may be negative, i.e., the first conveyor may convey opposite the production direction or backwards, respectively. It should be appreciated that in cases, in which the first conveyor conveys opposite the production direction and the second conveyor conveys in the production direction, the second conveyor has a higher conveying speed in production direction than the first conveyor, irrespective of how fast the respective conveyor conveys. The smaller conveying speed in the production direction of the first conveyor during depositing may facilitate and/or selectively control the folding of the second dough piece on the first dough piece.

Any of the previously described method steps may also be simultaneously applied to a plurality of first and/or second dough pieces. In particular, it is conceivable that a plurality of first and/or second dough pieces are respectively provided, transferred, deposited and or folded in a row, which may extend substantially transverse, in particular orthogonal, with respect to the production direction. It may be particularly beneficial, if a dough band is split into a plurality of dough strands prior to the severing of the dough pieces. The dough pieces may then be severed from each of the dough strands as explained above.

The disclosure further relates to a dough product, which has been made by a method of the type described above.

### BRIEF DESCRIPTION OF THE DRAWINGS

The disclosure relates to a method for making dough products as well as a dough product, of the type described above. In the following, an embodiment is exemplarily explained in more detail with reference to drawings.

FIG. 1 shows a schematic top view from above of a dough severing device.

FIG. 2 shows a schematic side view of a folding device.

FIG. 3 shows a schematic side view of a winding device.

### DETAILED DESCRIPTION

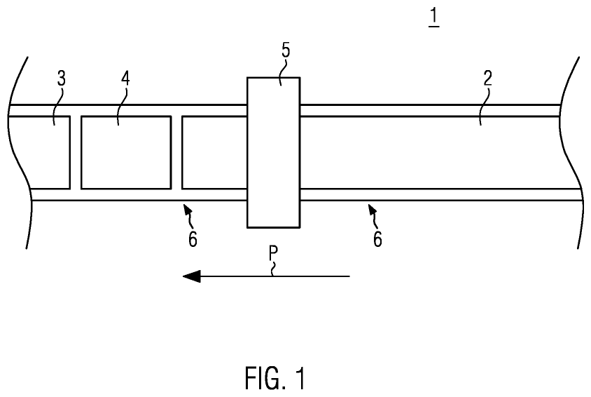

In FIG. 1, a dough severing device 1 is illustrated in schematic top view from above. The dough severing device 1 may be configured to sever dough pieces from a dough strand 2. In particular, a first dough piece 3 and a second dough piece 4 may be generated by consecutive severing procedures. The dough severing device 1 may comprise a cutting device 5, such as a knife, blade, punch, etc. The dough severing device 1 may, as it is known, further comprise conveying devices 6, such as conveyor belts. A production direction P may be defined as a direction, in which the dough strand 2 and/or the dough pieces 3, 4 pass through different processing steps. As can be seen with reference to FIG. 1, the production direction P may point from a location at which the dough strand 2 is supplied to a location at which the dough pieces 3, 4 severed from the dough strand 2 have been generated.

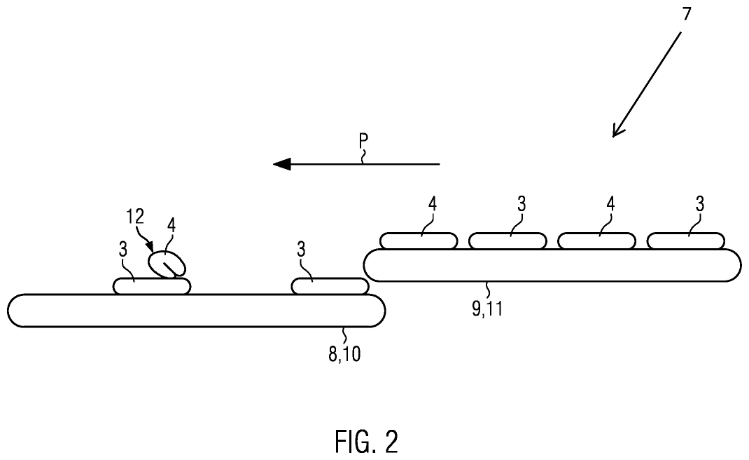

In FIG. 2 a folding device 7 is illustrated in a schematic side view. The folding device 7 may comprise a first conveyor 8. The folding device 7 may further comprise a second conveyor 9. The first conveyor 8 may comprise a first conveyor belt 10. The second conveyor 9 may comprise a second conveyor belt 11. The second conveyor, in particular the second conveyor belt, may be configured to transfer the first dough piece to the first conveyor 8, in particular to the first conveyor belt 10. FIG. 2 shows a state directly after the transfer of the first dough piece 3 from the second conveyor 9, in particular from the second conveyor belt 11, to the first conveyor 8, in particular to the first conveyor belt 10. In this state, the first dough piece 3 may be provided on the first conveyor 8, in particular on the first conveyor belt 10. As shown in FIG. 2, the second dough piece 4 may be supplied on the second conveyor 9, in particular on the second conveyor belt 11. While the first dough piece 3 is disposed on the first conveyor 8, in particular on the first conveyor belt 10, the second dough piece 4 may be deposited on the first dough piece 3. During the depositing, the second dough piece 4 may be folded. A second dough piece 4 deposited in a folded way can be seen on the left in FIG. 2. As shown there, a fold 12 of the folded second dough piece 4 may point in the production direction P.

The second conveyor 9 may be identical to one of the conveying devices 6 of the dough severing device 1. As can be seen in FIG. 2, the production direction P may point from a location, at which the dough pieces 3, 4 are consecutively conveyed, towards a location, at which the dough pieces 3, 4 are conveyed on top of each other.

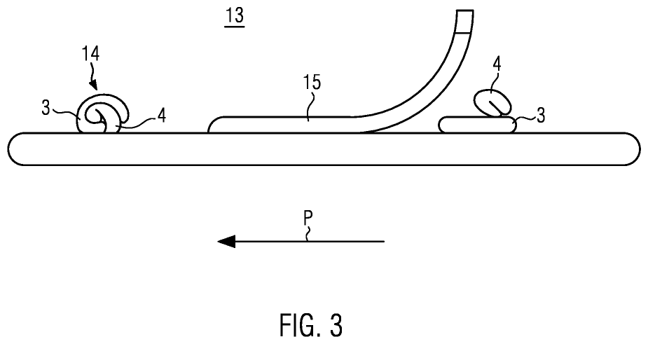

In FIG. 3, a winding device 13 is illustrated in a schematic side view. The winding device 13 may be configured to wrap the first and the second dough pieces 3, 4. A dough product 14 may be generated by wrapping the dough pieces 3, 4. The winding device 13 may comprise a winding mat 15 or a winding belt arranged above a conveyor, such as a conveyor belt. As can be seen in FIG. 3, the production direction P may point from a location, at which the dough pieces 3, 4 are conveyed on top of each other, towards a location, at which the dough pieces 3, 4 have formed the dough product 14 in a wrapped state.

What is claimed is:

1. A method for making dough products, the method comprising:
providing a first dough piece on a first conveyor,
supplying a second dough piece on a second conveyor,
depositing the second dough piece on the first dough piece, while the first dough piece is disposed on the first conveyor, wherein the second dough piece is folded during the depositing.

2. The method according to claim 1, further comprising transferring the first dough product from the second conveyor to the first conveyor prior to providing the first dough piece on the first conveyor.

3. The method according to claim 1, further comprising wrapping the first and the second dough pieces, after the second dough piece has been deposited on the first dough piece.

4. The method according to claim 1, wherein the first conveyor comprises a first conveyor belt.

5. The method according to claim 1, wherein the second conveyor comprises a second conveyor belt.

6. The method according to claim 1, wherein the second dough piece is folded in such a way that a fold points in a production direction.

7. The method according to claim 1, further comprising severing the first and the second dough pieces from a dough strand prior to providing the first dough piece on the first conveyor.

8. The method according to claim 2, further comprising severing the first and the second dough pieces from a dough strand prior to transferring the first dough product from the second conveyor to the first conveyor.

9. The method according to claim 7, wherein the first and the second dough pieces are consecutively severed.

10. The method according to claim 7, wherein the first dough piece and the second dough piece are consecutively severed and conveyed.

11. The method according to claim 1, wherein the second conveyor has a higher conveying speed in a production direction than the first conveyor during the depositing.

12. A dough product, which has been made by a method according to claim 1.
